(19) United States
(12) Patent Application Publication
(10) Pub. No.: US 2004/0157095 A1
(43) Pub. Date: Aug. 12, 2004

(54) Method for operating a fuel cell system which can be used in a vehicle, and associated fuel cell system

(76) Inventors: Rolf Bruck, Bergisch Gladbach (DE); Joachim Grosse, Erlangen (DE); Manfred Poppinger, Uttenreuth (DE); Meike Reizig, Bad Munstereifel (DE)

Correspondence Address: LERNER AND GREENBERG, PA, P O BOX 2480, HOLLYWOOD, FL, 33022-2480, US

(21) Appl. No.: 10/609,809

(22) Filed: Jun. 30, 2003

Related U.S. Application Data
(63) Continuation of application No. PCT/DE01/04888, filed on Dec. 21, 2001.

(30) Foreign Application Priority Data
Dec. 29, 2000 (DE) 100 65 306.5

(51) Int. Cl. H01M 8/04

(52) U.S. Cl. 429/13; 429/34

(57) ABSTRACT

A fuel cell system is operated by a supply of fuel and air. The air provides the oxygen required for the operation of the fuel cells in the form of an oxidant. The invention aims to prevent the fuel cell module from damage that might be caused when the motor vehicle is operated in different environments with possibly high pollution levels. To this end, the air is purified before it is supplied to the fuel cell system by way of an air purification device that is associated with the fuel cell module.

### CROSS-REFERENCE TO RELATED APPLICATION

This application is a continuation of copending International Application No. PCT/DE01/04888, filed Dec. 21, 2001, which designated the United States and which was not published in English.

### BACKGROUND OF THE INVENTION

### Field of the Invention

The invention relates to a method for operating a fuel cell system which can be used in a vehicle and is fed with fuel and air. In addition, the invention also relates to the associated fuel cell system for a motor vehicle, having at least one fuel cell module, the fuel cell module being supplied with fuel and air.

Numerous designs of fuel cell systems for supplying energy to electricomotive drives in motor vehicles are known. A common feature of these different fuel cell systems is the chemical reaction of hydrogen with oxygen to form water.

By way of example, the PEM fuel cell (polymer electrolyte membrane, proton exchange membrane), which operates with a proton-conducting membrane, operates with gasoline, methanol or another higher hydrocarbon as fuel, from which hydrogen is obtained as fuel gas by means of a reformer, and with oxygen from the ambient air. In particular the HT-PEM fuel cell, which is operated at higher temperatures, is per se insensitive to impurities, which applies in particular to the fuel gas. The oxygen as oxidizing agent is obtained from the ambient air, the starting point in principle being normal ambient air which, for example in a vehicle, can be taken from the airstream.

An earlier, commonly assigned German patent application DE 199 62 679 A1 (not prior art), defines a so-called HTM (high-temperature membrane) fuel cell or HT-PEM (high-temperature polymer electrolyte membrane) fuel cell which includes significant drawbacks of the previously known PEM fuel cells, specifically in particular the dependency on the water content, by selecting a new electrolyte and changing the operating conditions, in particular the temperature and the pressure. Commonly assigned U.S. Pat. No. 6,080,502 and corresponding German published patent application DE 196 02 315 A1 describe a liquid-cooled fuel cell with distribution passages in which the supply and distribution passages are arranged in such a way that in particular the admission of operating media to the cell surface along a distribution passage does not take place in punctiform fashion, but rather the entire cell surface is uniformly supplied with medium. U.S. Pat. No. 6,521,366 B1 and corresponding German patent application DE 199 08 099 A1 describe a PEM fuel cell system in which the anode circuit is at an increased operating pressure and a radiator for the fuel cell is cooled using a medium which is at ambient temperature. By contrast, in particular U.S. Pat. No. 5,794,732 A describes an electric vehicle with a fuel cell system as drive system, in which from the drive system is operated via a feedback line with a compressor for compressing supply air as oxidizing agent. The intention is to achieve an improved starting performance of the fuel cell system for the vehicle. These documents do not provide any details as to the quality of the operating media, in particular as to the ambient air as oxidizing agent for the fuel cells.

Although in particular the HT-PEM fuel cell is considered insensitive to impurities, it is nevertheless necessary to ensure certain standards of operating gases. By way of example, in a motor vehicle which is operated in urban areas under constantly fluctuating and different load conditions, it is necessary to rule out the possibility of faults occurring in the fuel cell system as a result of any impurities in the ambient air.

### SUMMARY OF THE INVENTION

It is accordingly an object of the invention to provide a fuel cell system for a motor vehicle and a method of operating a fuel cell system, which overcomes the above-mentioned disadvantages of the heretofore-known devices and methods of this general type and which ensures that the fuel cell system for the motor vehicle remains able to function in any ambient situation, and to provide an associated efficient fuel cell system.

With the foregoing and other objects in view there is provided, in accordance with the invention, a method for operating a fuel cell system, for example as a power generating installation in a motor vehicle. The method comprises:

operating a fuel cell module of the fuel cell system in self-aspirating mode; and

purifying air being fed to the fuel cell module for operating the fuel cell module with multistage air purification having at least two stages, including particle purification of the air and pollutant purification of the air.

In accordance with an added feature of the invention, the multistage air purification includes more than two purification stages.

According to the method of the invention, therefore, the air is purified before being used in the fuel cell, at least two-stage air purification involving particle purification, on the one hand, and pollutant purification, on the other hand, being provided. The purification advantageously takes place in a self-aspirating cell, i.e. when the oxidizing agent for the fuel cell is removed from the air of the airstream. In addition to the at least two-stage air purification, it is possible to provide for multistage operation.

With the above and other objects in view there is also provided, in accordance with the invention, a fuel system in a motor vehicle, comprising:

a fuel cell module operating with fuel and air; and

an air treatment unit connected upstream of the fuel cell module in an air feed direction, the air treatment unit including at least one filter for two-stage air treatment.

In accordance with an additional feature of the invention, the air treatment unit includes chemical air purification devices, adsorbers, and/or catalytically active devices such as catalytic coatings. Zeolites are advantageous adsorbers. The precious metals from the platinum group of the periodic system of elements are suitable catalysts for the catalytically active devices.

In accordance with a further feature of the invention, the filter is an n-stage filter (n>1). Preferably, the filter is a multifunction filter.

In accordance with again an added feature of the invention, the system includes a heat exchanger. Preferably, the heat exchanger includes a device for chemical air purification.

In accordance with another feature of the invention, the fuel cell module includes PEM fuel cells. Preferably, the system includes HT-PEM fuel cells that are typically operated at operating temperatures of about 120° C. to 200° C.

In accordance with a concomitant feature of the invention, the fuel cell module is mounted to a chassis of the motor vehicle in such as manner as to limit any adverse effect on a drag coefficient or any further characteristic parameters of the vehicle.

In other words, the fuel cell system according to the invention has a unit that advantageously includes adsorbers for the surface adsorption of pollutants and/or catalytic coatings for making pollutants chemically harmless, on the one hand, and filters for physical particle filtration, on the other hand. The unit is connected upstream of the fuel cell module, i.e., in an air feed stream. By way of example, catalytically active coatings can be applied in a simple way to surfaces of an integrated heat exchanger.

In the invention, the design of the filter has a particular function. It may be an n-stage filter which is designed as a multifunction filter.

Other features which are considered as characteristic for the invention are set forth in the appended claims.

Although the invention is illustrated and described herein as embodied in a method for operating a fuel cell system which can be used in a vehicle, and associated fuel cell system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic side view of a motor vehicle with a fuel cell system integrated therein; and

FIG. 2 is a block diagram illustrating a system comprising fuel cell module and a unit for air purification for use in the assembly of FIG. 1.

### DESCRIPTION OF THE PREFERRED EMBODIMENTS

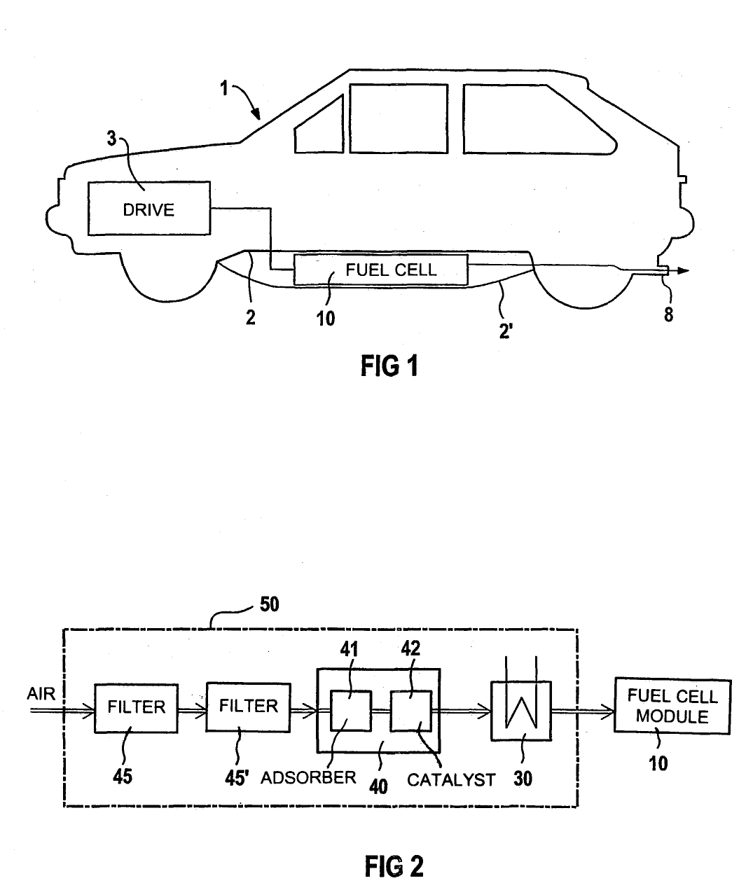

Referring now to the figures of the drawing in detail and first, particularly, to FIG. 1 thereof, there is shown a motor vehicle 1 and its electromotive drive 3. The drive 3 is supplied with energy from a fuel cell system, which, together with the associated system components, is fundamentally known. The fuel cell system substantially comprises a fuel cell module 10 and associated auxiliary equipment. At least the fuel cell module 10 has to be positioned in or on the chassis of the motor vehicle 1 in such a way that it can be supplied with air in a suitable way. By way of example, the fuel cell module 10 is arranged beneath the floor 2 of the motor vehicle 1 or in a free space formed by an intermediate floor 2′. The figure also indicates an exhaust 8 from which, when the fuel cell module 10 is operating with pure hydrogen and oxygen, the process water which is formed, or when hydrogen-rich gases with auxiliary constituents are used the auxiliary constituents, can escape.

In the fuel cell system arranged in the motor vehicle 1, the fuel cell module 10 is as far as possible supplied by the energy of the airstream, i.e. the fuel cell module 10 is self-aspirating. However, for low vehicle speeds and/or high loads there is usually an auxiliary blower. Additional information and exemplary embodiments in this regard may be found in our copending applications [atty. docket GR 00 P 20289], published as WO 02/053418 A1, [atty. docket GR 00 P 20293], published as WO 02/053402 A1, and [atty. docket GR 00 P 20291], published as WO 02/054518 A1. These copending disclosures are herewith incorporated by reference.

In this way, oxygen is provided as the oxidizing agent required for the fuel cell process.

The fuel cell system for mobile applications in a motor vehicle operates in accordance with the principle of membrane fuel cells with a membrane electrolyte. By making suitable use of mechanical means, i.e. by means of diverter plates and/or nozzle arrangements, the airstream can be made usable in such a manner that it ensures optimum use of the fuel cell module 10. The fuel cell module 10 should be of flat design and of limited height. In particular, it is also necessary for the aerodynamic properties of the motor vehicle, such as the drag coefficient or the like, not to be significantly impaired.

For the fuel cell system, fuel cells which operate with a solid electrolyte and are referred to as PEM (polymer electrolyte membrane, or proton exchange membrane) fuel cells are used for the fuel cell system. Fuel cells of this type are known from the prior art, fuel cells of this type, for mobile applications, advantageously being operated at higher temperatures than has hitherto been described in the specialist literature. The result is then what is known as a HT (high-temperature) PEM fuel cell system. For HT-PEM fuel cells of this type, operating temperatures of between 80° C. and 300° C., in particular in the range from 120° C. to 200° C., are used.

In particular the fuel cell module 10 with HT-PEM fuel cells may be of flat design. Specifically, a large number of PEM fuel cells are stacked, so that in this case it is possible to refer to a flat stack. A flat stack of this type is advantageously disposed beneath the automobile floor or, if it is not a passenger automobile, may also be arranged on the roof of the vehicle or at other suitable points on the vehicle chassis. This ensures that the airstream reaches the fuel cells in a suitable way.

FIG. 2 uses a fuel cell module 10 which—as described—comprises individual HT-PEM fuel cells which, by being stacked together, form the flat stack, referred to just as stack for short. Hydrogen or hydrogen-rich gas which is generated from a liquid fuel, such as for example gasoline or methanol, by reforming is fed to a stack of this type as fuel. In addition, ambient air is fed to the stack as an oxidizing agent. While HT-PEM fuel cells are relatively insensitive to impurities in the fuel gas and in particular tolerate CO impurity levels of up to 10,000 ppm, the situation is more problematic with regard to the oxidizing agent. For the fuel cell-operated vehicle to operate without problems in any environment, in particular including in urban traffic with temporary CO or CO₂ loads, an air treatment unit 50 with specific means for air purification is connected upstream of the fuel cell module 10.

The devices for air purification can operate according to chemical and/or physical principles and are present in combination in the overall unit for air treatment 50, or air purifier 50, as will be described in detail with reference to FIG. 2.

The unit 50 for air treatment includes a heat exchanger 30, an adsorber 41 and/or a catalyst, such as a catalytic coating 42. Suitable adsorbers are known, with zeolites being a suitable example. A precious metal, for example platinum or other precious metals, can be used as the catalytic coating. In practice, catalytic precious metal coatings of this type are already in use in conjunction with heat exchangers. The adsorber 41 and the catalytic coating 42 can form a common air purification unit 40.

In FIG. 2, a two-stage filter, comprising the filters 45 and 45′, is connected upstream of the unit 40 for chemical air purification. In the filter 45, particles which exceed a defined size are removed from the air flowing in, and particles which exceed a smaller size are removed in the filter 45′. It is possible to implement an n-stage filter which is or may be designed as a multifunction filter. It then also, by way of example, includes the adsorber 41 and/or the catalytic coating 42. This is advantageous if on the one hand particle purification and on the other hand pollutant purification are intended to take place. The heat exchanger 30, which sets the temperature of the air to a level that is suitable for operation of the fuel cell module 10, may also be integrated in the air purification unit.

It has been found that with a configuration as shown in FIG. 2 impurities in the ambient air which have hitherto caused problems and could adversely affect operation of a fuel cell system operating with air as oxidizing agent can be removed from the process air. This makes it possible to eliminate as far as possible disruptions to the fuel cell process caused by impurities. In this respect, when a fuel cell system with PEM and in particular HT-PEM fuel cells is used, the ambient air can in this case be used without problems to provide the oxidizing agent.

We claim:

1. A method for operating a fuel cell system, which comprises:
operating a fuel cell module of the fuel cell system in self-aspirating mode; and
purifying air being fed to the fuel cell module for operating the fuel cell module with multistage air purification having at least two stages, including particle purification of the air and pollutant purification of the air.

2. The method according to claim 1, which comprises performing the multistage air purification with more than two purification stages.

3. The method according to claim 1, which comprises operating the fuel cell system with PEM fuel cells.

4. The method according to claim 1, which comprises operating the fuel cell system with HT-PEM fuel cells.

5. The method according to claim 1, which comprises operating the fuel cell module as a power plant in a motor vehicle.

6. A fuel system in a motor vehicle, comprising:
a fuel cell module operating with fuel and air; and
an air treatment unit connected upstream of said fuel cell module in an air feed direction, said air treatment unit including at least one filter for two-stage air treatment.

7. The fuel cell system according to claim 6, wherein said air treatment unit includes purification devices selected from the group consisting of chemical air purification devices, adsorbers, and catalytically active devices.

8. The fuel cell system according to claim 6, wherein said catalytically active devices include a catalytic coating.

9. The fuel cell system according to claim 6, wherein said adsorbers are zeolites.

10. The fuel cell system according to claim 6, wherein said catalytically active devices include a coating with a precious metal from the platinum group of the periodic system of elements.

11. The fuel cell system according to claim 6, wherein said filter is an n-stage filter, and n is an integer greater than 1.

12. The fuel cell system according to claim 6, wherein said filter is a multifunction filter.

13. The fuel cell system according to claim 6, which further comprises a heat exchanger.

14. The fuel cell system according to claim 13, wherein said heat exchanger includes a device for chemical air purification.

15. The fuel cell system according to claim 6, wherein said fuel cell module includes PEM fuel cells.

16. The fuel cell system according to claim 6, wherein said fuel cell module includes HT-PEM fuel cells.

17. The fuel cell system according to claim 6, wherein said fuel cell module is mounted to a chassis of the motor vehicle such that a drag coefficient and further characteristic parameters of the vehicle are not adversely affected.
